(19) United States
(12) Patent Application Publication
(10) Pub. No.: US 2008/0261570 A1
(43) Pub. Date: Oct. 23, 2008

(54) Radio Communication Apparatus and Method of Control

(75) Inventors: Matthew Peter John Baker, Canterbury (GB); Paul Bucknell, Brighton (GB); Olivier Jean-Michel Hus, Redhill (GB); Timothy James Moulsley, Caterham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,587

(22) PCT Filed: Oct. 20, 2006
(86) PCT No.: PCT/IB2006/053869

§ 371 Date: Apr. 25, 2008

(30) Foreign Application Priority Data
Oct. 28, 2005 (GB) 0522031.4

(51) Int. Cl. H04Q 7/38

(52) U.S. Cl. 455/414.1

(57) ABSTRACT

A method of operating a radio communication apparatus (100), comprises receiving an access parameter transmitted intermittently by a radio station (200), storing a value of the latest received access parameter, and transmitting an access signal. It further comprises receiving a validity indicator transmitted by the radio station (200), and if the validity indicator has a first value, employing the stored value of the latest received access parameter to transmit the access signal, and if the validity indicator has a second value, waiting to receive the next random access parameter and employing the value of said next access parameter to transmit the access signal.

### FIELD OF THE INVENTION

The invention relates to a radio system, a radio communication apparatus, a radio station, a method of operating a radio communication apparatus, and a method of operating a radio station. The invention has application in, particularly but not exclusively, mobile communications systems such as the Universal Mobile Telecommunication System (UMTS).

### BACKGROUND OF THE INVENTION

In current versions of UMTS, a delay occurs between the origination of a call, either to or from a mobile station, and the start of the mobile station's random access transmissions, as the mobile station has to await reception of random access parameters which are transmitted periodically but possibly infrequently on the broadcast channel from a base station.

In UMTS, parameters describing how random access transmissions are performed are signalled intermittently on the broadcast channel (BCH). These parameters may be updated, for example according to the uplink loading in a cell. A mobile station (MS) making a random access attempt must first receive the parameters from the BCH. In UMTS, the random access parameters are transmitted in a System Information Block (SIB) known as SIB7. The parameters included in SIB7 include the following elements:
Uplink Interference (UL), value range −110 to −70 dBm (requiring 6 bits)
Dynamic Persistence level, per Physical Random Access Channel (PRACH) listed in SIB5 and SIB6, value range 1 to 8 (requiring 3 bits). This is used as an input to the function controlling MS transmission probability on the random access channel (RACH)
Expiration time factor, value range 1 to 8 (requiring 3 bits). The expiration factor indicates to the MS for how long it may regard the contents of the SIB7 as valid

The frequency of transmission of SIB7 (e.g. every x frames where x is an integer) is indicated in a Master Information Block (MIB) transmitted every 8 frames on the BCH and time-multiplexed with the SIBs. One time frame is 10 ms.

In order to minimise the signalling load on the BCH, it is desirable to reduce the frequency of transmitting the random access parameters. However, when a call to or from a MS is originated, the MS then experiences a longer delay waiting to receive the latest random access parameters before it can make its random access transmission.

Some possible ways of reducing the random access delay are:
Signal the SIB7 information in each paging message in order to provide the MS with the random access parameters without further delay in the case of mobile-terminated calls (MTCs). A delay reduction can also be achieved for mobile-originated calls (MOCs) if the MS listens to paging messages for other MSs. However, a drawback of this scheme is that it increases the load on the paging channel (PCH), effectively turning the paging channel into a broadcast channel.
Modify SIB7 to allow it to specify that the random access parameters have infinite validity. This has the advantage of enabling the network to reduce the random access delay without increasing the signalling load. It also avoids putting broadcast-type information onto the PCH. However, the drawback of this scheme is that it makes it difficult for the network to adjust the random access parameters in response to changes in uplink cell loading. Once a MS has received a set of random access parameters with infinite validity, it will never try to receive another set of random access parameters.

### SUMMARY OF THE INVENTION

An object of the invention is to reduce the delay of access transmission.

According to a first aspect of the invention there is provided a radio system comprising a radio communication apparatus and a radio station, said radio station, comprising: transmitter means for transmitting intermittently an access parameter for use by the radio communication apparatus in transmitting an access message; wherein the transmitter means is adapted to transmit a validity indicator; said radio communication apparatus comprising:

receiver means for receiving said access parameter from the radio station; storage means for storing a value of the latest received access parameter; and transmitter means for transmitting an access signal; wherein the receiver means is adapted to receive the validity indicator transmitted by the radio station; and further comprising control means adapted to employ the stored value of the latest received access parameter for the transmission of the access signal, or wait to receive the next access parameter and employ the value of said next access parameter for the transmission of the access signal, depending on at least a value of said validity indicator.

According to a second aspect of the invention there is provided a radio communication apparatus, comprising: receiver means for receiving an access parameter transmitted intermittently by a radio station; storage means for storing a value of the latest received access parameter; and transmitter means for transmitting an access signal; wherein the receiver means is adapted to receive a validity indicator transmitted by the radio station; and further comprising control means adapted to employ the stored value of the latest received access parameter for the transmission of the access signal, or wait to receive the next access parameter and employ the value of said next access parameter for the transmission of the access signal, depending on at least the value of validity indicator.

According to a third aspect of the invention there is provided a radio station, comprising: transmitter means for transmitting intermittently an access parameter for use by a radio communication apparatus in transmitting an access message; wherein the transmitter means is adapted to transmit a validity indicator indicating whether a radio communication apparatus wanting to transmit an access message should use a stored value of the most recently transmitted access parameter, or should wait to receive the next transmitted access parameter.

According to fourth aspect of the invention, there is provided a method of operating a radio communication apparatus, comprising: receiving an access parameter transmitted intermittently by a radio station; storing a value of the latest received access parameter; and transmitting an access signal; further comprising: receiving a validity indicator transmitted by the radio station; and depending on at least the value of the validity indicator, employing the stored value of the latest received access parameter to transmit the access signal, or waiting to receive the next random access parameter and employing the value of said next access parameter to transmit the access signal.

According to a fifth aspect of the invention there is provided a method of operating a radio station, comprising: transmitting intermittently an access parameter for use by a radio communication apparatus in transmitting an access message; and transmitting a validity indicator indicating whether a radio communication apparatus wanting to transmit an access message should use a stored value of the most recently transmitted access parameter, or should wait to receive the next transmitted access parameter.

Thus, an indicator is transmitted by a radio station (for example a base station), to a radio communication apparatus (for example a mobile station) to indicate whether the radio communication apparatus shall use its most-recently-stored value of the access parameter (or plural access parameters), or whether it shall not transmit an access signal until it has received new values for the access parameter(s). The indicator may be transmitted on a paging channel in conjunction with a paging message for the radio communication apparatus, or may be transmitted on a broadcast channel at regular intervals, for example in conjunction with signalling that informs the radio communication apparatus how frequently access parameter values are transmitted on the broadcast channel.

The invention enables the delay of access transmissions to be reduced, while avoiding large additional signalling loads.

### BRIEF DESCRIPTION OF THE DRAWING

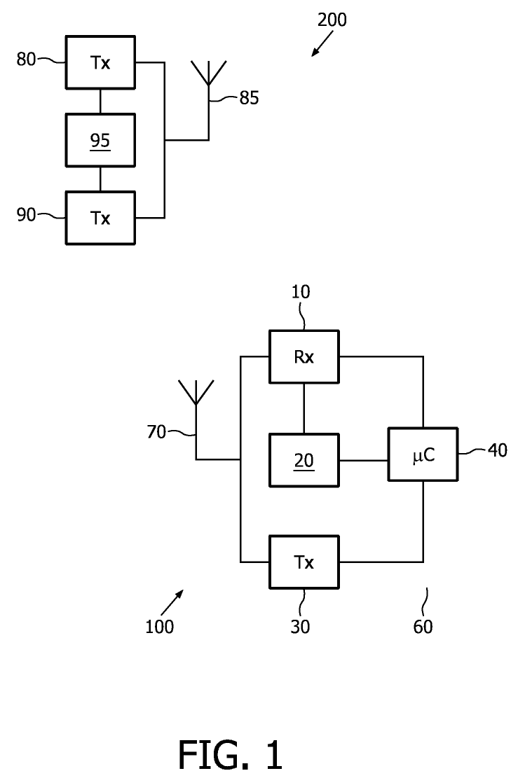

The invention will now be described, by way of example, with reference to the accompanying drawing, wherein FIG. 1 is a block schematic diagram of a radio communication system comprising a radio communication apparatus and a radio station.

### DETAILED DESCRIPTION

Referring to FIG. 1, there is illustrated a radio communication system comprising a radio communication apparatus 100 and a radio station 200.

The radio station 200 comprises a transmitter 80 for transmitting intermittently via an antenna 85 an access parameter for use by the radio communication apparatus 100 in transmitting an access message. The access parameter may be a random access parameter for use by the radio communication apparatus 100 when transmitting a random access message. One or more access parameters may be transmitted. The transmitter 80 is adapted to transmit a validity indicator indicating whether the radio communication apparatus 100 wanting to transmit an access message should use its stored value of the most recently transmitted access parameter, or should wait to receive the next transmitted access parameter. The access parameter and the validity indicator may be generated by an access controller 95 coupled to the transmitter 80. The access controller 95 may generate the access parameter and validity indicator based at least partly on signals received by a receiver 90 coupled to access controller 95 and to the antenna 85. The access controller 95 may be implemented in, for example, a microprocessor.

The transmitter 80 may be adapted to transmit the validity indicator on a paging channel.

The transmitter 80 may be adapted to transmit a paging message comprising the validity indicator, either addressed to the radio communication apparatus 100 or to another non-illustrated radio communication apparatus.

The transmitter 80 may be adapted to transmit the validity indicator in a broadcast message.

The transmitter 80 may be adapted to transmit the broadcast message further comprising an indication of a time interval between transmissions of the validity indicator.

The transmitter 80 may be adapted to transmit the broadcast message further comprising an indication of a time interval between transmissions of the access parameter.

The radio communication apparatus 100 comprises a receiver 10 coupled to an antenna 70 for receiving an access parameter transmitted intermittently by the radio station 200, a store 20 coupled to the receiver 10 for storing a value of the latest received access parameter, and a transmitter 30 coupled to the antenna 70 for transmitting an access signal. The requirement to transmit the access signal may be, for example, in response to an outgoing call initiated at the radio communication apparatus 100, or in response to an incoming call transmitted by the radio station 200. The receiver 10 is adapted to receive a validity indicator transmitted by the radio station 200 and to deliver the validity indicator to a controller 40. The controller 40 is adapted to, if the validity indicator has a first value, employ the stored value of the latest received access parameter for the transmission of the access signal, and if the validity indicator has a second value, wait to receive the next access parameter and employ the value of said next access parameter for the transmission of the access signal.

The transmitter 30 may be adapted to transmit the access signal in response to receipt of a paging message.

The receiver 10 may be adapted to receive the validity indicator and the paging message on a paging channel.

The receiver 10 may be adapted to receive the paging message comprising the validity indicator.

The controller 40 may be adapted to, in response to receipt of the paging message, wait for receipt of the validity indicator before permitting the transmission of the access signal.

The transmitter 30 may be adapted to transmit the access signal in response to a call originated at the radio communication apparatus 100, in which case the controller 40 is adapted to wait for receipt of the validity indicator before permitting the transmission of the access signal.

The receiver 10 may be adapted to receive the validity indicator in a broadcast message.

The receiver 10 may be adapted to receive the broadcast message including an indication of a time interval between transmissions of the validity indicator.

The receiver 10 may be adapted to receive the broadcast message including an indication of a time interval between transmissions of the access parameter.

The receiver 10 may be adapted to receive the validity indicator in a paging message addressed to another radio communication apparatus.

The controller 40 may be adapted to, if the validity indicator has the first value, employ the stored value of the latest received access parameter only if it was received within a predetermined time period, and otherwise to employ the value of the next received access parameter.

The receiver 10 may be adapted to receive an indication of the value of the predetermined time period from the radio station 200.

In one embodiment of the invention applicable to UMTS, a single extra bit is added to the UMTS PAGING TYPE 1 message transmitted on the PCH, to indicate to the MS either:
to use the last-stored random access parameter(s), or
to wait and receive the next SIB7 before making a random access transmission.
   For each network-originated random access attempt, this therefore enables the network to select between minimising delay, by using the last-stored parameter value(s), and optimising the random access parameter(s), with longer access delay while the MS waits for the next SIB7. This avoids the additional signalling load on the PCH that would result from signalling the full SIB7 information in each paging message.

In a second embodiment of the invention applicable to UMTS, one bit in the MIB is used to indicate whether the MS should either
use the last-stored random access parameter(s), or
wait and receive the next SIB7 before accessing the RACH.

Optionally, the indicator bit in the MIB can be coded together with the parameter known in UMTS as SIB_REP that indicates how frequently the SIB7 information is transmitted.

As the MIB is always transmitted every 8 frames in UMTS, each frame having a duration of 10 ms, this means that the delay in determining the random access parameters to use can be limited to a maximum of 80 ms if the new indicator bit in the MIB is set to indicate “use the last-stored random access parameters”. If a SIB7 happened to be received in the meantime, the delay would be further shortened. This embodiment also enables the network to select between minimising delay and optimising the random access parameters, while also avoiding any extra loading on the PCH. This method has the advantage compared to the use of “infinite validity” random access parameters that the network can change the selection of minimal delay versus optimal random access parameters every 80 ms if desired.

This embodiment has the advantage of providing the same benefit for both MTCs and MOCs, without requiring MSs to process paging messages for other MSs, which may not be available in all circumstances.

In a variation of both the above embodiments, the value of the extra bit corresponding to “use the last-stored random access parameters” could alternatively be defined to mean “use the last-stored random access parameters provided that they were received more recently than X ms ago”, where X could be specified as a single suitable value.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of radio communication and which may be used instead of or in addition to features already described herein.

1. A radio system comprising a radio communication apparatus and a radio station,
said radio station including transmitter means for transmitting intermittently an access parameter for use by the radio communication apparatus in transmitting an access message; wherein the transmitter means is adapted to transmit a validity indicator;
said radio communication apparatus including receiver means for receiving said access parameter from the radio station; storage means for storing a value of the latest received access parameter; and transmitter means for transmitting an access signal; wherein the receiver means is adapted to receive the validity indicator transmitted by the radio station; and further comprising control means adapted to employ the stored value of the latest received access parameter for the transmission of the access signal, or wait to receive the next access parameter and employ the value of said next access parameter for the transmission of the access signal, depending on at least a value of said validity indicator.

2. The system as claimed in claim 1, wherein the radio communication apparatus further comprises transmitter means adapted to transmit the access signal in response to receipt of a paging message.

3. The system as claimed in claim 2, wherein the transmitter means of the radio station is adapted to transmit the validity indicator on a paging channel.

4. The system as claimed in claim 3, wherein the transmitter means of the radio station is adapted to transmit a paging message comprising the validity indicator.

5. The system as claimed in claim 2, wherein the control means of the radio communication apparatus is adapted to, in response to receipt of the paging message, wait for receipt of the validity indicator before the transmission of the access signal.

6. The system as claimed in claim 1, wherein the transmitter means of the radio communication apparatus is adapted to transmit the access signal in response to a call originated at the radio communication apparatus, and wherein in response to the call originated at the radio communication apparatus, the control means is adapted to wait for receipt of the validity indicator before the transmission of the access signal.

7. The system as claimed in claim 1, wherein the transmitter means of the radio station is adapted to transmit the validity indicator in a broadcast message.

8. The system as claimed in claim 7, wherein the transmitter means of the radio station is adapted to transmit the broadcast message further comprising an indication of a time interval between transmissions of the validity indicator.

9. The system as claimed in claim 8, wherein the receiver means of the radio communication apparatus is adapted to receive the broadcast message including an indication of a time interval between transmissions of the access parameter.

10. The system as claimed in claim 3, wherein the receiver means of the radio communication apparatus is adapted to receive the validity indicator in a paging message addressed to a different radio communication apparatus.

11. The system as claimed in any of claim 1, wherein the control means of the radio communication apparatus is adapted to, if the validity indicator has a first value, employ the stored value of the latest received access parameter only if it was received within a predetermined time period, and otherwise to employ the value of the next received access parameter.

12. The system as claimed in claim 11, wherein the receiver means of the radio communication apparatus is adapted to receive an indication of the value of the predetermined time period from the radio station.

13. A radio communication apparatus, comprising:
receiver means for receiving an access parameter transmitted intermittently by a radio station;
storage means for storing a value of the latest received access parameter;
transmitter means for transmitting an access signal; wherein the receiver means is adapted to receive a validity indicator transmitted by the radio station; and
control means adapted to employ the stored value of the latest received access parameter for the transmission of the access signal, or wait to receive the next access parameter and employ the value of said next access parameter for the transmission of the access signal, depending on at least the value of validity indicator.

14. (canceled)

15. A method of operating a radio communication apparatus, comprising:
receiving an access parameter transmitted intermittently by a radio station;
storing a value of the latest received access parameter;
transmitting an access signal;
receiving a validity indicator transmitted by the radio station; and
depending on at least the value of the validity indicator, employing the stored value of the latest received access parameter to transmit the access signal, or waiting to receive the next random access parameter and employing the value of said next access parameter to transmit the access signal.

16. (canceled)
